(19) United States
(12) Patent Application Publication
(10) Pub. No.: US 2026/0008681 A1
(43) Pub. Date: Jan. 8, 2026

(54) SILICA POWDER, RESIN COMPOSITION, AND DISPERSION THEREOF

(71) Applicant: TOKUYAMA CORPORATION, Yamaguchi (JP)

(72) Inventors: Satoshi WATANABE, Yamaguchi (JP); Nao MIZUKAMI, Yamaguchi (JP)

(73) Assignee: TOKUYAMA CORPORATION, Yamaguchi (JP)

(21) Appl. No.: 19/117,276

(22) PCT Filed: Sep. 25, 2024
(86) PCT No.: PCT/JP2024/034041

§ 371 Date: Mar. 31, 2025

(30) Foreign Application Priority Data
Oct. 3, 2023 (JP) 2023-172291

(51) Int. Cl. C01B 33/18; C08K 3/36; C09C 1/28

(52) U.S. Cl. CPC C01B 33/18; C08K 3/36; C09C 1/28; C01P 2002/70; C01P 2004/32; C01P 2004/51

(57) ABSTRACT

The present invention provides silica powder by which resin composition resin excellent in a filling characteristic and narrow gap penetrability, allowing a filler to be mixed in a sufficient filling amount, in a case where the silica powder is used as a resin filler of a semiconductor encapsulant and the like. The silica powder of the present invention is characterized in that a volume-based cumulative 50% diameter D50 by a laser diffraction scattering method is 0.05 to 2.00 μm, and an amount of independent particles exceeding 5 μm detected by a dynamic image analysis method is less than 100 ppm.

### TECHNICAL FIELD

The present invention relates to silica powder, resin composition, and a dispersion that can be suitably used as a filler for a semiconductor encapsulant, a liquid crystal sealant, a film, and the like.

### BACKGROUND ART

In recent years, with the increase in performance and reduction in size and weight of electronic devices, a form of a semiconductor package to be mounted has also been increased in integration and density, and reduced in thickness. For practical use of such a semiconductor package, it is essential to design an integrated circuit and to develop an encapsulant suitable for the design.

For example, epoxy resin is mainly used as an underfill material filling a portion between a semiconductor chip and a wiring substrate, but the epoxy resin, the semiconductor chip, and the wiring substrate have different coefficient of thermal expansion. For this reason, if a connection portion cannot absorb stress, a crack may occur in the connection portion. In order to suppress the occurrence of this crack, a filler having a relatively small coefficient of thermal expansion such as silica is dispersed in the underfill material. At this time, in order to suppress the coefficient of thermal expansion of an encapsulant, it is required to increase the filling amount of a low-expansion-coefficient filler. Further, it is required that voids are not generated when an underfill material to which a filler is added permeates the gap, that is, sufficient narrow gap penetrability is required.

In order to increase a filling amount of the filler, hydrophilic fumed silica powder having excellent dispersibility, small, dispersed particle size, and narrow particle size distribution during dispersion has been proposed (Patent Document 1). However, in the silica powder described in Patent Document 1, since dispersed particle size is small, voids are not generated when the silica powder is caused to permeate into a gap, but a thickening effect on resin composition is induced, and viscosity of the resin composition filled with the silica powder is increased, and for this reason, there remains a problem that a sufficient filling amount cannot be obtained.

Further, a method of improving affinity with resin by treating a surface of silica particles having high uniformity in particle size with a silane coupling agent has been proposed (for example, Patent Document 2). In the silica particles described in Patent Document 2, it has been shown that when conventional silica particles are surface-treated with an epoxy group-containing silane coupling agent, aggregation of silica particles alone during drying of the silica particles can be suppressed by further surface-treating the silica particles with a nitrogen-containing compound and increase in viscosity at the time of filling the silica particles with resin can be suppressed. In addition, it has also been shown that there is no need for classification by suppressing aggregation. However, although agglomerated particles may be reduced, an amount of coarse particles that do not pass through a sieve with opening size of 20 μm defined as an amount of coarse particles still remains at 0.1% or more, and in a case of being used as a filler of a encapsulant, voids are generated at the time of gap penetration, and there has remained a problem that a molding defect is caused.

### PRIOR ART DOCUMENTS

### Patent Documents

Patent Document 1: JP 2014-152048 A
Patent Document 2: JP 2019-189509 A

### SUMMARY OF THE INVENTION

### Problems to be Solved by the Invention

Therefore, an object of the present invention is to provide silica powder excellent in gap penetration. More specifically, an object of the present invention is to provide silica powder by which resin composition resin excellent in narrow gap penetrability and a filling characteristic allowing a filler to be blended while a sufficient filling amount is obtained can be obtained.

### Means for Solving the Problems

As a result of intensive studies to solve the above problem, the present inventors have found that even silica powder containing particles (agglomerated particle and independent particle) having large particle size, silica powder having specific particle size distribution with reduced independent particles having large particle size is excellent in a filling characteristic when being kneaded with resin to fill the silica powder and narrow gap penetrability of obtained resin composition, and has high fluidity and excellent handleability in a powder state. Note that, in the present invention, independent particles mean primary particles.

That is, the silica powder of the present invention is silica powder containing a spherical silica particle, whose dispersion liquid dispersed by a dispersion method A below has a volume-based cumulative 50% diameter D50 of 0.05 to 2.00 μm and a volume-based cumulative 100% diameter D100 of 5 μm or less by a laser diffraction scattering method, and whose dispersion liquid dispersed by a dispersion method B below has an amount of particles having particle size exceeding 5 μm of 100 ppm or more and an amount of independent particles of less than 100 ppm as detected by a dynamic image analysis method.

[Dispersion method A]A method of dispersing a 5 mass % ethanol suspension of silica powder in an ultrasonic homogenizer at a frequency of 20 kHz for five minutes.
[Dispersion method B]A method in which a 0.1 mass % aqueous suspension of silica powder is dispersed for 30 minutes in an ultrasonic cleaner at a frequency of 40 kHz.

In the silica powder of the present invention, the spherical silica particle is preferably surface-treated with a silane coupling agent, and a component amount of the silane coupling agent is preferably 2.0 to 22.0 molecules/nm².

Further, the ratio (D100/D50) of a volume-based cumulative 50% diameter D50 (μm) to a 100 volume-based cumulative 100% diameter D100 (μm) obtained by a laser diffraction scattering method is preferably 1 or more and 5 or less, and also an amount (V90) of coarse particles of the spherical silica powder, which is obtained by Formula (1) from a volume-based cumulative 50% diameter D50 and a volume-based cumulative 90% diameter D90 obtained by a laser diffraction scattering method, is preferably 10 or more and less than 100.

$$V 90 = \{ ( D 90 - D 50 ) / D 50 \} \times 100 \qquad ( 1 )$$

### Effects of the Invention

Since the silica powder of the present invention contains a specific amount of particles having a particle diameter exceeding 5 μm detected after being dispersed by the dispersion method B, handleability is excellent, a volume-based cumulative 50% diameter D50 measured after dispersion by the dispersion method A is within a specific particle size range, a volume-based cumulative 100% diameter D100 is less than specific particle size, and independent particles having particle size exceeding 5 μm detected after dispersion by the dispersion method B is reduced (an amount of independent particles is less than a specific amount), and for this reason, resin composition to which the silica powder is added can achieve both excellent filling characteristics and narrow gap penetrability. Therefore, the silica powder is suitable as a filler for a semiconductor encapsulant or a semiconductor mounting adhesive. In particular, the silica powder can be suitably used as a filler of high-density mounting resin.

The silica powder contains independent particles and agglomerated particles, and if resin composition after the silica powder is added and kneaded contains a large amount of independent particles or agglomerated particles (hereinafter, these are also referred to as particles having large particle size) having large particle size, in a case where the resin composition is used as a filler for a semiconductor encapsulant or a semiconductor mounting adhesive, penetration of the resin composition is inhibited by large particles at the time of gap penetration, and the resin composition tends to be poor in narrow gap penetrability.

Even though the silica powder of the present invention contains a specific amount of particles having particle size exceeding 5 μm detected after dispersion by the dispersion method B applying weak shear, resin composition using the silica powder of the present invention is excellent in narrow gap penetrability because a volume-based cumulative 100% diameter D100 measured after dispersion by the dispersion method A applying strong shear is less than specific particle size and an amount of independent particles having particle size exceeding 5 μm detected after dispersion by the dispersion method B is less than a specific amount, and this is presumed to be because the silica powder of the present invention contains agglomerated particles and independent particles in a state not applied with shear before being added to resin and kneaded, but in resin composition after being kneaded with resin and applied with shear, the agglomerated particles are dispersed by strong shear to become particles having smaller particle size. On the other hand, independent particles having particle size exceeding 5 μm detected after dispersion by the dispersion method B do not change in particle size due to strong shear, but in the silica powder of the present invention, an amount of the independent particles is reduced to less than a specific amount, so that narrow gap penetrability is not affected.

### MODE FOR CARRYING OUT THE INVENTION

Hereinafter, the silica powder of the present invention will be described in detail based on an embodiment.

### [Silica Powder]

The silica powder of the present invention consists of spherical silica particles, and dispersion liquid of the silica powder dispersed by a dispersion method A below has a volume-based cumulative 50% diameter D50 of 0.05 to 2.00 μm and a volume-based cumulative 100% diameter D100 of 5 μm or less by a laser diffraction scattering method.

[Dispersion method A]A method of dispersing a 5 mass % ethanol suspension of silica powder in an ultrasonic homogenizer at a frequency of 20 kHz for five minutes.

Since the dispersion method A applies strong shear with a low-frequency ultrasonic homogenizer, a measurement result by a laser diffraction scattering method obtained by dispersing in the dispersion method A represents a state of the silica powder in a kneading process when filling resin. By measuring D100 of dispersion liquid of the silica powder by the dispersion method A, it can be shown that large particles are not detected in particle size distribution, and particles may be dispersed if large shear is applied. However, since a detection level by the laser diffraction scattering method is on the order of percent and detection sensitivity is low, it is not possible to detect and quantify a trace amount of particles exceeding D100 in the silica powder.

Here, the volume-based cumulative 50% diameter D50 is 0.05 to 2.00 μm. If the volume-based cumulative 50% diameter D50 is less than 0.05 μm, a thickening effect on resin composition is induced, and viscosity of the resin composition filled with the silica powder is increased, and for this reason, a sufficient filling amount tends not to be obtained, and if the volume-based cumulative 50% diameter D50 exceeds 2.00 μm, when gap penetration of resin composition filled with the silica powder is performed, permeation is inhibited due to a narrow gap and a small difference in particle size, and voids tend to be generated. If the volume-based cumulative 50% diameter D50 is 0.05 to 2.00 μm, viscosity of the resin composition can be kept low even when resin is filled with a large amount of the silica powder.

Further, the volume-based cumulative 100% diameter D100 by a laser diffraction scattering method of dispersion liquid dispersed by the dispersion method A of the silica powder is 5 μm or less. The volume-based cumulative 100% diameter D100 is preferably less than 3 μm.

Here, when the volume-based cumulative 100% diameter D100 exceeds 5 μm, existing particles inhibit gap penetration, and generate voids to cause a molding defect. If D100 is 5 μm or less and an amount of independent particles exceeding 5 μm is less than 100 ppm by a method described later, even when a large amount of the silica powder is added to resin, excellent narrow gap penetrability can be exhibited when gap penetration is performed on resin composition. The volume-based cumulative 100% diameter D100 is preferably 3 μm or less.

Furthermore, in the silica powder of the present invention, an amount of particles exceeding 5 μm detected by a dynamic image analysis method of dispersion liquid dispersed by a dispersion method B below is 100 ppm or more, and an amount of independent particles exceeding 5 μm is less than 100 ppm.

[Dispersion method B]A method in which a 0.1 mass % aqueous suspension of silica powder is dispersed for 30 minutes in an ultrasonic cleaner at a frequency of 40 kHz.

In addition to using the laser diffraction scattering method for particle size distribution measurement of dispersion liquid dispersed by the dispersion method A applying strong shear as described above, an amount of particles exceeding 5 μm and an amount of independent particles exceeding 5 μm were measured for dispersion liquid dispersed by the dispersion method B by a dynamic image analysis method. Since the dispersion method B applies weak shear by an ultrasonic cleaner at a high frequency, particles exceeding 5 μm detected by a dynamic image analysis method include agglomerated particles that are dispersed by strong shear to become particles having small particle size and independent particles that are not dispersed even by strong shear. Independent particles exceeding 5 μm are particles that are not dispersed even by strong shear. Note that, in order to distinguish and detect the agglomerated particles and independent particles, an image is filtered using a parameter indicating a shape. In “circularity” calculated by dynamic image analysis, particles having circularity of 0.90 or more are determined to be independent spherical particles having high circularity, while particles having circularity of less than 0.90 are determined to be amorphous and are determined to be agglomerated particles having a high possibility of being formed by aggregation of primary particles.

An amount of particles exceeding 5 μm detected by a dynamic image analysis method of the silica powder is 100 ppm or more. As described above, the particles detected here include both agglomerated particles in which primary particles are aggregated and independent particles. If this amount of particles is 100 ppm or more, fluidity of the silica powder can be enhanced, and handleability when the silica powder is added to resin can be enhanced.

On the other hand, an amount of independent particles exceeding 5 μm is less than 100 ppm. The amount is preferably less than 50 ppm, and more preferably less than 10 ppm. When the amount of independent particles exceeding 5 μm is 100 ppm or more, there is a possibility that the existing independent particles do not penetrate into a gap, and voids may be generated to cause a molding defect. If the amount is less than 100 ppm, even when a large amount of spherical silica particles are added to resin, excellent narrow gap penetrability can be exhibited when gap penetration is performed on resin composition.

That is, if an amount of particles exceeding 5 μm detected by a dynamic image analysis method of dispersion liquid dispersed by the dispersion method B is 100 ppm or more and an amount of independent particles exceeding 5 μm is less than 100 ppm, the silica powder of the present invention before being applied with shear has high fluidity because agglomerated particles exceeding 5 μm and independent particles exceeding 5 μm exist in an amount of 100 ppm or more, and handleability when the silica powder is added to resin is excellent, and, in the silica powder after being dispersed in resin by application of strong shear, agglomerated particles exceeding 5 μm are dispersed by strong shear, and independent particles exceeding 5 μm are in a state of less than 100 ppm, and even when a large amount of spherical silica particles are added to resin, excellent narrow gap penetrability is exhibited when gap penetration is performed. Further, if an amount of particles exceeding 3 μm detected by a dynamic image analysis method of dispersion liquid dispersed by the dispersion method B is 100 ppm or more and an amount of independent particles exceeding 3 μm is less than 100 ppm, the silica powder of the present invention before being applied with shear has high fluidity because agglomerated particles exceeding 3 μm and independent particles exceeding 3 μm exist in an amount of 100 ppm or more, and handleability when the silica powder is added to resin is excellent, and, in the silica powder after being dispersed in resin by application of strong shear, agglomerated particles exceeding 3 μm are dispersed by strong shear, and independent particles exceeding 3 μm are in a state of less than 100 ppm, and even when a large amount of spherical silica particles are added to resin, time required for gap penetration can be made shorter and excellent narrow gap penetrability is exhibited when gap penetration is performed.

Further, circularity of particles of 5 μm or less detected by a dynamic image analysis method of the silica powder is preferably 0.90 or more. If circularity is 0.90 or more, the proportion of spherical particles increases and fluidity increases, so that excellent narrow gap penetrability can be exhibited.

An aspect ratio of particles of 5 μm or less detected by a dynamic image analysis method of the silica powder is preferably 0.92 or more. If the aspect ratio is 0.92 or more, the proportion of spherical particles increases and fluidity increases, so that excellent narrow gap penetrability can be exhibited.

In the present invention, spherical silica particles may be surface-treated with a silane coupling agent. A component amount of the silane coupling agent is preferably 2.0 to 22.0 molecules/nm², and more preferably 4.0 to 18.0 molecules/nm². If a component amount of the silane coupling agent is 2.0 to 22.0 molecules/nm², a reactive hydroxyl group on a surface of silica particles can be sufficiently blocked from resin. If the component amount is 2.0 molecules/nm² or more, a reactive hydroxyl group on a surface of silica particles is blocked from organic resin and affinity tends to be improved, and further, if the component amount is 22.0 molecules/nm² or less, an amount of an excessive silane coupling agent is small and dispersibility of silica particles tends to be improved.

Particle size distribution of the silica powder can be represented by the ratio (D100/D50) when the cumulative 50 volume % particle size of volume-based particle size distribution obtained by a laser diffraction scattering method is D50 and maximum particle size is D100. The ratio (D100/D50) is preferably 1 or more and 5 or less. When (D100/D50) is 1 or more and 5 or less, spherical silica particles tend to fill resin in a form close to the densest packing, and even if filling is performed with a large amount of spherical silica particles, the resin not contained in a particle gap increases, and the viscosity of resin composition can be kept low.

Furthermore, an amount of coarse particles of the silica powder can be represented by V90 calculated by Formula (1) below.

$$V 90 = \{ ( D 90 - D 50 ) / D 50 \} \times 100 \qquad ( 1 )$$

D50: Cumulative 50 volume % particle size of volume-based particle size distribution obtained by laser diffraction scattering method
D90: Cumulative 90 volume % particle size of volume-based particle size distribution obtained by laser diffraction scattering method
V90 is preferably 10 or more and less than 100, more preferably 10 to 95, and still more preferably 20 to 90. If V90 is 10 or more and less than 100, excellent gap penetrability can be obtained when resin composition is allowed to permeate into a gap.

### [Application]

Use of the silica powder of the present invention is not particularly limited. For example, the silica powder can be used as a filler of a semiconductor encapsulant or a semiconductor mounting adhesive, a filler of a die attach film or a die attach paste, or a filler of resin composition such as an insulating film of a semiconductor package substrate. In particular, spherical silica particles obtained in the present invention can be suitably used as a filler of resin composition for high-density mounting.

Furthermore, the silica powder of the present invention can also be used as abrasive grains of a chemical mechanical polishing (CMP) abrasive material, abrasive grains for grindstone used for grinding and the like, a toner external additive, an additive of a liquid crystal sealing material, a dental filler, an inkjet coating agent, or the like.

### [Method of Producing Silica Powder]

Next, a method of producing the silica powder of the present invention will be described.

Silica-based spherical particles are classified to obtain silica powder consisting of spherical silica particles. Details will be described below.

### <Silica-Based Spherical Particles>

The silica-based spherical particles used in the present invention are desirably silica-based spherical particles having average particle size of 0.05 to 2.00 μm by a laser diffraction scattering method.

Further, as the silica-based spherical particles, wet silica-based spherical particle dispersion liquid obtained by a sol-gel method may be used. Here, in the sol-gel method, hydrolysis and polycondensation of silicon alkoxide are performed in a reaction medium including water containing a catalyst and an organic solvent to produce silica sol, and the silica sol is gelled, and then wet silica-based spherical particle dispersion liquid is obtained.

Further, as the silica-based spherical particles, dry silica-based spherical particles obtained by a flame method may be used. Here, in the flame method, a silicon compound is burned for production, and growing and aggregating are performed in flame and in the vicinity of flame so that dry silica-based spherical particles are obtained. For example, WO 2020/175160 A discloses that in a method of producing silica by burning a silicon compound, a burner having a concentric multiple tube structure of triple tubes or more is installed in a reactor provided with a cooling jacket portion around the burner, and a flame combustion condition and a cooling condition are adjusted, so that silica powder in which a cumulative 50% mass diameter of mass-based particle size distribution obtained by a centrifugal sedimentation method is 300 nm or more and 500 nm or less can be obtained.

### <Classification Processing>

By classification processing of silica-based spherical particles, spherical silica particles in which independent particles are reduced can be obtained. For example, the wet silica-based spherical particle dispersion liquid is subjected to wet filtration to remove contained independent particles. That is, by filtering the wet silica-based spherical particle dispersion liquid, if independent particles, and further agglomerated particles and agglomerates are generated together with reaction residues on a filter medium and the like, these are also separated. Here, as the filter medium, in a filter for wet filtration, one having opening size of 5 μm or less can be used without particular limitation on a type, and one having opening size of 3 μm or less can also be preferably used. If the opening size is too small, not only filterability is lowered, but also the average particle size of silica particles to be filtered varies greatly from the above range, and thus a lower limit of the opening size is usually 1 μm although it depends on average particle size of intended powder. A material of the filter is not particularly limited, and examples of the material include resin (polypropylene, PTFE, and the like) and metal. From the viewpoint of preventing metal impurities from being mixed, it is preferable to use a filter made from resin.

Further, since dry silica-based spherical particles are powder in terms of a production method, they may be dispersed in a solvent and filtered in a wet manner. The solvent at this time is not particularly limited, but it is preferable to select a solvent in which dry silica-based particles are easily dispersed.

Further, for example, classification processing using inertial force such as liquid cyclone or wind power classification may be used. A medium at this time is not particularly limited, but it is preferable to use liquid in a case of wet silica-based spherical particles and to use air in a case of dry silica-based spherical particles from the viewpoint of excellent dispersibility in a medium.

### <Separation Treatment>

In the present embodiment, spherical silica particles obtained by classification may be recovered as a cake by solid-liquid separation as needed. Further, a coagulant may be added to form a weak aggregate, and then solid-liquid separation may be performed. By adding a coagulant, solid and liquid can be separated and easily recovered. A method of filtration is not particularly limited, and for example, publicly-known methods such as vacuum filtration, pressure filtration, and centrifugal filtration can be applied.

Further, the coagulant to be added is not particularly limited, but from the viewpoint of a possibility of mixing into spherical silica particles to be obtained, a coagulant including a compound containing no metal element component such as carbon dioxide, ammonium carbonate, ammonium hydrogen carbonate, and ammonium carbamate is suitable.

### <Drying Treatment>

In the present embodiment, a cake containing spherical silica particles obtained by separation treatment can be dried as necessary to obtain silica powder consisting of spherical silica particles.

A method of drying is not particularly limited, and a publicly-known method such as air blow drying or vacuum drying can be employed. However, disintegration tends to be more easily performed by drying under reduced pressure than by drying under atmospheric pressure, and, for this reason, it is preferable to employ vacuum drying.

Further, drying temperature is preferably 35° C. to 200° C., more preferably 50° C. to 200° C., particularly preferably 80° C. to 200° C., and especially preferably 120° C. to 200° C. Drying temperature of 35° C. to 200° C. is advantageous from the viewpoint of obtaining silica powder which is easily disintegrated.

### <Firing Treatment>

In the present embodiment, silica powder containing spherical silica particles obtained by the drying treatment can be fired as necessary.

In the silica powder containing spherical silica particles after drying, a dispersion medium absorbed in particles is not completely removed, and a silanol group remains, and in particular, a pore exists in spherical silica particles using wet silica-based spherical particles. In order to highly remove a dispersion medium in the particles and crush a silanol group to obtain solid silica, it is preferable to further perform firing treatment according to an application. That is, silica particles treated in the firing process are preferable not only from the viewpoint of reducing an amount of a silanol group on a particle surface but also from the viewpoint of removing a dispersion medium remaining in the particles. In a case where a solvent remaining in the particles is used as a filler of resin, a bubble and the like are generated when heating is performed, which causes a decrease in yield. In particular, the above is remarkable in a semiconductor encapsulant application and a liquid crystal sealant application having a high filling rate. Therefore, it is preferable to provide the process particularly in production of silica particles used for a semiconductor encapsulant application and a liquid crystal sealant application.

If firing temperature during the firing treatment is too low, it is difficult to remove a dispersion medium component, and if the firing temperature is too high, fusion of silica particles occurs, and therefore it is preferable to perform the firing treatment at 300° C. to 1300° C. or 600° C. to 1200° C. Firing time is not particularly limited as long as a remaining dispersion medium is removed, but if the firing time is too long, productivity is lowered, and for this reason, it is sufficient to perform firing by maintaining temperature in a range of 0.5 to 48 hours, more preferably 2 to 24 hours after the temperature is raised to target calcination temperature. Atmosphere during firing is not particularly limited, and firing can be performed under inert gas such as argon or nitrogen, or under air atmosphere.

The silica powder of the present invention can also be used after disintegration processing by a publicly-known disintegrating means in order to further reduce agglomerates as necessary. A method of disintegration is not particularly limited, and for example, a publicly-known method such as a ball mill or a jet mill can be employed.

[Surface Treatment with Silane Coupling Agent]

Spherical silica particles may be surface-treated with a silane coupling agent. Details will be described below.

### <Silane Coupling Agent>

Examples of the silane coupling agent include those represented by Formula (2) below.

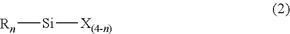

In Formula (2), R is an organic group having 1 to 18 carbon atoms, X is a hydrolyzable group, and n is an integer of 1 to 3.

Examples of the above X include an alkoxy group having 1 to 3 carbon atoms such as a methoxy group, an ethoxy group, and a propoxy group and/or a halogen atom such as a chlorine atom, and among these, a methoxy group and/or an ethoxy group is preferable. Note that, in a case where n is 1 or 2, a plurality of Xs may be the same or different, but are preferably the same. Note that, although n is an integer of 1 to 3, n is preferably 1 or 2, and particularly preferably 1.

Examples of the silane coupling agent mentioned as Formula (2) above include methyltrimethoxysilane, methyltriethoxysilane, hexyltrimethoxysilane, decyltrimethoxysilane, phenyltriethoxysilane, vinyltrimethoxysilane, vinyltriethoxysilane, 3-methacryloyloxypropyltrimethoxysilane, 3-methacryloyloxypropyltriethoxysilane, 3-acryloyloxytrimethoxysilane, 3-glycidoxypropyltrimethoxysilane, 3-glycidoxypropyltriethoxysilane, 3-aminopropyltrimethoxysilane, 3-aminopropyltriethoxysilane, N-(2-aminoethyl)-3-aminopropyltrimethoxysilane, N-(2-aminoethyl)-3-aminopropylmethyldimethoxysilane, N-phenyl-3-aminopropyltrimethoxysilane, N, N-dimethyl-3-aminopropyltrimethoxysilane, N, N-diethyl-3-aminopropyltrimethoxysilane, 4-styryltrimethoxysilane, and the like.

### <Surface Treatment Agent (Other Additives)>

Further, other than a silane coupling agent, at least one type of surface treatment agent selected from silicone oil, siloxanes, and/or silazanes may be added. The surface treatment agent may be added simultaneously with a silane coupling agent, or a silane coupling agent may be added after the surface treatment agent is added. Furthermore, the surface treatment agent may be added after a silane coupling agent is added. By this, spherical silica particles having various surface properties are obtained. For example, spherical silica particles including a trimethylsilyl group and an epoxy group can be easily obtained.

In a case of silicone oil, a usage amount of the surface treatment agent is preferably 0.05 to 80 parts by mass, more preferably 0.1 to 60 parts by mass, and most preferably 1 to 20 parts by mass, with respect to 1 part by weight of spherical silica particles. Similarly, in the case of siloxanes, the usage amount is preferably 0.001 to 40 parts by mass, more preferably 0.003 to 30 parts by mass, and most preferably 0.005 to 20 parts by mass with respect to 1 part by weight of spherical silica particles. Similarly, in the case of silazanes, the usage amount is preferably 0.001 to 40 parts by mass, more preferably 0.003 to 30 parts by mass, and most preferably 0.005 to 20 parts by mass with respect to 1 part by weight of the silica powder.

### <Mixing>

Spherical silica particles and a silane coupling agent are mixed by a conventionally publicly-known method. For example, spherical silica particles are placed in a mixing container, and a predetermined amount of a silane coupling agent is added dropwise, by spraying, or the like in a state where the spherical silica particles are fluidized by swinging, stirring, or the like. For example, silica powder is added into a container, and stirring by rotation of a stirring blade is started. A silane coupling agent is added to the silica powder using a peristaltic pump. An addition rate can be appropriately changed according to an additional amount.

It is preferable to continue stirring for 10 minutes or more after adding the silane coupling agent. By continuing the stirring, the silane coupling agent can be uniformly attached to a surface of the spherical silica particles.

Examples of the mixing container include a Henschel-type mixing device in which a stirring blade, a mixing blade, and the like are installed, a Lödige-type mixer, an air blender in which air is mixed by air flow, a V blender in which mixing is performed by rotation or swinging of a container main body, a double cone type mixing device, a rocking mixer, and the like.

### <Heating Treatment>

By performing heating treatment, a part of an added silane coupling agent reacts (that is, forms a chemical bond) with a surface of silica particles, and a remaining part of the silane coupling agent remains (that is, physically adsorbs) on a surface of the silica particles without forming a chemical bond. When the temperature at which the heating treatment is performed is low, progress of the reaction is delayed, and production efficiency is lowered, and when the temperature is high, decomposition of the silane coupling agent and a surface treatment agent and generation of aggregation due to a rapid polymerization reaction are promoted. Therefore, depending on a silane coupling agent and the like to be used, it is generally preferable to perform the heating treatment at 25° C. to 300° C., preferably 40° C. to 250° C.

Heating treatment time only needs to be appropriately determined according to reactivity of a silane coupling agent and the like to be used. It is usually possible to obtain a sufficient reaction rate in 1 hour or more and 500 hours or less.

Further, in the case where heating treatment can be performed in a mixing container used for mixing, mixed powder may be directly subjected to the heating treatment in the device.

### <Drying Treatment>

Drying temperature is not particularly limited, but when the temperature is high, a silane coupling agent component (physical adsorption) having no chemical bonding volatilizes and is removed from spherical silica particles, which is not preferable, and when the temperature is low, a by-product cannot be sufficiently removed. Therefore, the drying temperature is preferably 25° C. to 200° C., more preferably 25° C. to 180° C., and still more preferably 25° C. to 150° C. By drying at 25° C. or higher, a by-product generated when a silane coupling agent reacts with the surface of silica particles can be sufficiently removed.

A device used for drying is not particularly limited, and a conventionally publicly-known drying device can be used. Further, in a case where drying can be performed in a reaction vessel used in heating treatment, treated powder may be directly subjected to drying treatment in a device.

Pressure in a device during drying is preferably pressure equal to or more than atmospheric pressure. Specifically, it is preferably 1000 hPa or more. By drying at pressure equal to or more than atmospheric pressure, an unreacted silane coupling agent can be sufficiently removed. If the pressure is 1000 hPa or more, a by-product can be sufficiently removed without volatilizing a physically adsorbed silane coupling agent component.

Drying time is not particularly limited, and may be appropriately selected according to a condition at the time of drying, for example, drying temperature, pressure, and the like, but in general, by setting drying time to about 1 to 48 hours, surface-treated silica powder from which a by-product is removed can be obtained.

### [Dispersion]

The silica powder of the present invention can be dispersed in a solvent to form a dispersion. The solvent used for dispersing the silica powder is not particularly limited as long as it is a solvent in which the silica powder is easily dispersed.

As such a solvent, for example, water and organic solvents such as alcohols, ethers, and ketones can be used. Examples of the alcohols include methanol, ethanol, and 2-propyl alcohol. As the solvent, a mixed solvent of water and any one or more of the organic solvents may be used. Note that, in order to improve stability and dispersibility of the silica powder, various additives such as a dispersant such as a surfactant, a thickener, a wetting agent, an antifoaming agent, or an acidic or alkaline pH adjusting agent may be added. Further, pH of the dispersion is not limited.

Applications of the dispersion include filling a semiconductor encapsulant or a semiconductor mounting adhesive. The dispersion, that is, the silica powder dispersed in a solvent in advance is easily dispersed in resin. For example, an underfill material in which a filler is well dispersed can be easily prepared by mixing resin and the dispersion and then removing a solvent.

### [Resin Composition]

A type of resin with which the silica powder is mixed for producing the resin composition of the present invention is not particularly limited. A type of the resin may be appropriately selected according to a desired application, and examples of the resin include epoxy resin, acrylic resin, silicone resin, olefin-based resin, polyimide resin, and/or polyester-based resin.

As a method of producing the resin composition, a publicly-known method only needs to be appropriately employed, and the silica powder only needs to be mixed with various types of resin and other components mixed as necessary.

In the case where a dispersion of the present invention is mixed with resin, it is possible to obtain resin composition in which a dispersion state of the silica powder in the resin is better than that in the case where the silica powder in a dried state is mixed with the resin. That a dispersion state of the silica powder is better means that the number of agglomerated particles in resin composition is reduced. For this reason, it is possible to further improve performance of both a viscosity characteristic and gap penetrability of the resin composition containing the silica powder of the present invention as a filler.

Examples of applications of the resin composition include a semiconductor encapsulant and a semiconductor mounting adhesive, and the resin composition mixed with the silica powder is suitable for the applications because a coefficient of thermal expansion can be suppressed.

### SUMMARY

As understood from the above description, the silica powder according to a first aspect of the present invention is silica powder containing a spherical silica particle, whose dispersion liquid dispersed by the dispersion method A below has a volume-based cumulative 50% diameter D50 of 0.05 to 2.00 μm and a volume-based cumulative 100% diameter D100 of 5 μm or less by a laser diffraction scattering method, and whose dispersion liquid dispersed by the dispersion method B below has an amount of particles exceeding 5 μm of 100 ppm or more and an amount of independent particles exceeding 5 μm of less than 100 ppm as detected by a dynamic image analysis method.

[Dispersion method A]A method of dispersing a 5 mass % ethanol suspension of silica powder in an ultrasonic homogenizer at a frequency of 20 kHz for five minutes.
[Dispersion method B]A method in which a 0.1 mass % aqueous suspension of silica powder is dispersed for 30 minutes in an ultrasonic cleaner at a frequency of 40 kHz.

According to such silica powder, it is possible to achieve both an excellent filling characteristic and narrow gap penetrability without inhibiting permeation of resin composition at the time of gap penetration while obtaining a large filling amount when the silica powder is added to resin.

The silica powder according to a second aspect of the present invention is the silica powder according to the first aspect described above, in which a spherical silica particle is surface-treated with a silane coupling agent, and a component amount of the silane coupling agent is 2.0 to 22.0 molecules/nm².

A silica powder according to a third aspect of the present invention is the silica powder according to the first aspect or the second aspect described above, in which the ratio (D100/D50) of a volume-based cumulative 50% diameter D50 (μm) to a 100 volume-based cumulative 100% diameter D100 (μm) obtained by a laser diffraction scattering method is 1 or more and 5 or less.

A silica powder according to a fourth aspect of the present invention is the silica powder according to the first aspect or the second aspect described above, in which an amount (V90) of coarse particles of the silica powder, which is obtained by Formula (1) from a volume-based cumulative 50% diameter D50 and cumulative 90% diameter D90 obtained by a laser diffraction scattering method, is 10 or more and less than 100.

$$V 90 = \{ ( D 90 - D 50 ) / D 50 \} \times 100 \qquad ( 1 )$$

Resin composition according to a fifth aspect of the present invention is formed by dispersing the silica powder according to the first aspect or the second aspect described above in resin.

A dispersion according to a sixth aspect of the present invention is formed by dispersing the silica powder according to the first aspect or the second aspect described above in a solvent.

### EXAMPLE

Hereinafter, the present invention will be specifically described with reference to examples in the present embodiment, but the present invention is not limited by these examples at all.

A method for measuring and evaluating each physical property of the silica powder is as described below.

### (Volume-Based Particle Size Distribution by Laser Diffraction Scattering Method)

About 0.5 g of silica powder was weighed using an electronic balance into a 50 mL glass bottle, 10 g of ethanol was added, the mixture was dispersed in a condition of a frequency of 20 kHz for 5 minutes using an ultrasonic homogenizer (Sonifier® 250 manufactured by Branson®), and after that, a volume-based cumulative 50% diameter D50 (μm), a volume-based cumulative 100% diameter D100 (μm), and a volume-based cumulative 90 volume % diameter D90 (μm) of spherical silica particles were measured by a laser diffraction scattering method particle size distribution measuring device (LS 13 320 manufactured by Beckman Coulter, Inc.). From the obtained D50 and D90, an amount (V90) of coarse particles of the surface-treated silica powder obtained by Formula (1) was obtained.

$$V 90 = \{ ( D 90 - D 50 ) / D 50 \} \times 100 \qquad ( 1 )$$

### (Dynamic Image Analysis Method)

### (Method of Measuring Circularity, Aspect Ratio, Amount of Particles Exceeding 5 μm and Amount of Independent Particles Exceeding 5 μm by Dynamic Image Analysis)

(1) In the dynamic image analysis method, dispersion liquid obtained by dispersing silica powder in pure water was used. The dispersion liquid was prepared by preparing a 0.1 mass % suspension obtained by adding 0.03 g of silica powder and 0.1 mL of 0.1M sodium hydroxide solution to 30 g of ultrapure water, and then performing dispersion for 30 minutes with an ultrasonic cleaner at a frequency of 40 kHz.

(2) The dispersion liquid obtained in (1) was measured with a dynamic image analysis device (Parshe Analyzer manufactured by Hosokawa Micron Group) to obtain a particle image in 0.015 mL of the dispersion liquid. For the obtained particle image, “equivalent circle diameter d”, “circularity”, and the “aspect ratio” were obtained by calculation inside the device.

(3) In the case where an amount of particles exceeding 5 μm and an amount of independent particles exceeding 5 μm were calculated from the obtained particle images, only particles of “equivalent circle diameter d>5 μm” were selected, and the number of particles exceeding 5 μm was measured. Furthermore, particles exceeding 5 μm were identified by “circularity≥0.9” and “aspect ratio ≥0.92”, and the number of independent particles exceeding 5 μm was measured. Here, using the equivalent circle diameter d [μm] of particles, a particle amount W [ppm] of each of particles exceeding 5 μm and independent particles exceeding 5 μm was calculated from a calculation method of (4) below. In a case of calculating an amount of particles exceeding 3 μm and an amount of independent particles exceeding 3 μm, calculation was performed in a similar manner except that only particles of “equivalent circle diameter d>3 μm” were selected from the particle image obtained in (2).

(4) Mass w [g] per particle was calculated from Formula (i) using the equivalent circle diameter d [μm] obtained from dynamic image analysis. As p, a value of true density ρ of amorphous silica=2.2 [g·m³] was used.

$$w = ρ \times π / 6 \times {( d \div {10}^{6} )}^{3} \qquad ( i )$$

This operation was performed on each particle detected by dynamic image analysis, and the weight of each particle was calculated. The sum of all of them was defined as total weight ws [g], and the particle amount W [ppm] in an amount of spherical silica particles subjected to measurement was obtained from Formula (ii).

$$W = ws / ( 0.015 \times ( 0.1 / 100 ) \qquad ( ii )$$

Note that a lower detection limit in this measurement method was calculated by measuring 0.015 mL of dispersion liquid obtained by adding a known amount of 10 ppm of standard particles 1 (4206A manufactured by Thermo Fisher Scientific) to the dispersion liquid obtained in (1) described above. An amount of independent particles obtained by measurement of dispersion liquid to which standard particles were added represents a detection amount of the standard particles, and from this result, a lower detection limit of an amount of particles exceeding 5 μm was determined to be 10 ppm. Further, similarly, dispersion liquid to which standard particles 2(4204A manufactured by Thermo Fisher Scientific) were added was measured, and a lower detection limit of an amount of particles exceeding 3 μm was determined to be 10 ppm.

### (Method of Measuring Component Amount of Silane Coupling Agent in Silica Powder)

Using a carbon amount of silica powder (described later), a BET specific surface area of silica powder (described later), and the number of carbon atoms of a silane coupling agent (no unit), a component amount of the silane coupling agent (molecules/nm²) was obtained using a formula below.

Component amount (molecules/nm²) of silane coupling agent=carbon amount (mass %) of spherical silica particles/100/12 (atomic weight of carbon)/{number of carbon atoms of silane coupling agent−N}×Avogadro's number (particles/mol)/BET specific surface area (m²/g) of silica powder/10¹⁸

(In the formula, the number of carbon atoms of the silane coupling agent is the number of carbon atoms in a molecular formula of the silane coupling agent to be used. For example, in the case where KBM-403 manufactured by Shin-Etsu Chemical Co., Ltd. is used, the number of carbon atoms of the silane coupling agent is 9 since the silane coupling agent has a molecular formula C₉H₂₀O₅Si. Wherein, N is the number of carbon atoms of a hydrolyzing group X of the silane coupling agent ×2. For example, when X is a methoxy group, N is 2, and when X is an ethoxy group, N is 4. The Avogadro's number is 6.02×10²³ (particles/mol).)

### (Carbon Amount)

A carbon amount (mass %) was measured using a total nitrogen total carbon measurement device (SUMIGRAPH NC-TR22 manufactured by Sumika Chemical Analysis Service, Ltd.). Note that a measurement silica sample was 50 to 100 mg.

### (BET Specific Surface Area)

A BET specific surface area S (m²/g) was measured by a nitrogen adsorption BET single point method using a specific surface area measuring device (SA-1000 manufactured by Shibata Rikagaku).

### (Evaluation of Gap Penetrability of Silica Powder)

Here, 36 g of silica powder was added to a mixture of 17 g of bisphenol F type epoxy resin (YDF-8170C manufactured by NIPPON STEEL Chemical & Material Co., Ltd.) and 7 g of an amine curing agent (KARAHARD A-A manufactured by Nippon Kayaku Co. Ltd.), and the mixture was hand-kneaded. Hand-kneaded resin composition was preliminarily kneaded with a planetary centrifugal mixer (Awatori Rentaro AR-500 manufactured by TIHINKY CORPORATION) (Kneading: 1000 rpm, 8 minutes, defoaming: 2000 rpm, 2 minutes). The resin composition after preliminary kneading was stored in a thermostatic water bath at 25° C., and then kneaded using a three roll mill (BR-150HCV roll diameter φ63.5 manufactured by AIMEX CO., Ltd.). Kneading conditions were kneading temperature of 25° C., an inter-roll distance of 20 μm, and the number of times of kneading of eight. The obtained resin composition was defoamed for 30 minutes under reduced pressure using a vacuum pump (TSW-150 manufactured by SATO VAC INC.) to obtain kneaded resin composition. The kneaded resin composition was dropped at an entrance of a gap heated to 110° C. with two sheets of glass stacked in advance so as to have a gap of 30 μm, and a high-temperature penetration test was performed. The presence or absence of a flow mark was evaluated by visual observation of appearance. In a case where no flow mark was observed, it was determined that gap penetrability was good, and when a flow mark was observed, it was determined that gap penetrability was poor. Here, if gap penetrability is good, the silica powder is considered to be excellent in filling property and a viscosity characteristic.

### Example 1-1

As a reaction medium, 4.3 parts by mass of methanol, 1.7 parts by mass of isopropanol, and 1.4 parts by mass of ammonia solution (25 mass %) were prepared, reaction temperature was set to 40° C., and the mixture was stirred. After the above, a mixture of 0.2 parts by mass of tetraethoxysilane, 0.4 parts by mass of methanol, and 0.1 parts by mass of isopropanol as raw materials was put into the reaction medium to prepare silica seed particles. Next, a raw material of 100 parts by mass of tetramethoxysilane and 28.5 parts by mass of methanol were supplied into the reaction medium, and at the same time, 42.8 parts by mass of ammonia solution (25 mass %) was supplied to grow and synthesize sol-gel silica particles. After completion of the supply, stirring was continued for one hour to obtain silica-based spherical particle dispersion liquid having average particle size of 1.0 μm. The silica-based spherical particle dispersion liquid was subjected to wet filtration using a polypropylene filtration filter having opening size of 3 μm to remove independent particles. After the above, 0.9 parts by mass of dry ice was put into the liquid and then left for 20 hours. In a stage where 20 hours elapsed, the sol-gel silica particles settled, and a cake was obtained after solid-liquid separation using quantitative filter paper (holding particle size: 6 μm). Furthermore, vacuum drying was performed at 100° C. for 15 hours. Subsequently, firing was performed at 800° C. for 10 hours in air atmosphere. Furthermore, disintegration processing was performed using a jet mill to obtain silica powder 1. Table 1 shows properties and a preparation condition of the silica powder, and Table 2 shows physical properties of the silica powder.

### Example 1-2

Silica powder 2 was prepared and measured in a similar manner to Example 1-1, except that the polypropylene filtration filter used in wet filtration was changed from opening size of 3 μm to opening size of 5 μm. Table 1 shows properties and a preparation condition of the silica powder, and Table 2 shows physical properties of the silica powder.

### Example 1-3

In Example 1-1, the reaction medium was changed to 21.4 parts by mass of methanol, 8.6 parts by mass of isopropanol, and 7.1 parts by mass of ammonia solution (25 mass %). After the above, silica seed particles were prepared by changing a raw material for preparing silica seed particles to 0.9 parts by mass of tetraethoxysilane, 2.0 parts by mass of methanol, and 0.6 parts by mass of isopropanol. After the above, silica powder 3 was prepared and measured in a similar manner to Example 1-1. Table 1 shows properties and a preparation condition of the silica powder, and Table 2 shows physical properties of the silica powder.

### Example 1-4

In Example 1-1, the reaction medium was changed to 83.3 parts by mass of methanol, 33.3 parts by mass of isopropanol, and 27.8 parts by mass of ammonia solution (25 mass %). After the above, silica seed particles were prepared by changing a raw material for preparing silica seed particles to 3.3 parts by mass of tetraethoxysilane, 7.8 parts by mass of methanol, and 2.2 parts by mass of isopropanol. Next, a raw material after preparing silica seed particles was changed to 100 parts by mass of tetramethoxysilane, 27.8 parts by mass of methanol, and 44.4 parts by mass of ammonia solution (25 mass %). After the above, silica powder 4 was prepared and measured in a similar manner to Example 1-1. Table 1 shows properties and a preparation condition of the silica powder, and Table 2 shows physical properties of the silica powder.

### Example 1-5

In Example 1-1, the reaction medium was changed to 50.0 parts by mass of methanol and 8.3 parts by mass of ammonia solution (25 mass %). After the above, a mixture of 100 parts by mass of tetramethoxysilane, 10.0 parts by mass of methanol, and 46.7 parts by mass of ammonia solution (25 mass %) as raw materials was put into the reaction medium to grow and synthesize sol-gel silica particles. After the above, silica powder 5 was prepared and measured in a similar manner to Example 1-1. Table 1 shows properties and a preparation condition of the silica powder, and Table 2 shows physical properties of the silica powder.

### Example 1-6

In Example 1-1, the reaction medium was changed to 1.8 parts by mass of methanol, 0.7 parts by mass of isopropanol, and 0.6 parts by mass of ammonia solution (25 mass %). After the above, silica seed particles were prepared by changing a raw material for preparing silica seed particles to 0.1 parts by mass of tetraethoxysilane, 0.2 parts by mass of methanol, and 0.1 parts by mass of isopropanol. After the above, silica powder 6 was prepared and measured in a similar manner to Example 1-1. Table 1 shows properties and a preparation condition of the silica powder, and Table 2 shows physical properties of the silica powder.

### Example 1-7

Silica powder 7 was prepared and measured in a similar manner to Example 1-6, except that the polypropylene filtration filter used in wet filtration was changed from opening size of 3 μm to opening size of 5 μm. Table 1 shows properties and a preparation condition of the silica powder, and Table 2 shows physical properties of the silica powder.

### Example 1-8

In this example, 5 parts by mass of dry silica-based spherical particles having average particle size of 0.38 μm (SILFIL NSS-40D manufactured by Tokuyama Corporation) was added to 100 parts by mass of pure water to prepare dry silica-based spherical particle dispersion liquid. This dry silica-based spherical particle dispersion liquid was subjected to wet filtration using a polypropylene filtration filter having opening size of 3 μm to remove independent particles, and silica particles 8 were prepared and measured. Table 1 shows properties and a preparation condition of the silica powder, and Table 2 shows physical properties of the silica powder.

### Example 1-9

Silica powder 9 was prepared and measured in a manner similar to Example 1-8 except that dry silica-based spherical particles (SILFIL NSS-24D manufactured by Tokuyama Corporation) having average particle size of 0.24 μm were used instead of dry silica-based spherical particles (SILFIL NSS-40D manufactured by Tokuyama Corporation) having average particle size of 0.38 μm. Table 1 shows properties and a preparation condition of the silica powder, and Table 2 shows physical properties of the silica powder.

### Example 1-10

Dry silica-based spherical particles (SILFIL NSS-40D manufactured by Tokuyama Corporation) having average particle size of 0.38 μm were classified with a wind power classification device to prepare silica powder 10, and the silica powder was measured. Table 1 shows properties and a preparation condition of the silica powder, and Table 2 shows physical properties of the silica powder.

### Comparative Example 1-1

Silica powder A was prepared and measured in a similar manner to Example 1-1 except that wet filtration using a polypropylene filtration filter with opening size of 3 μm was not performed. Table 1 shows properties and a preparation condition of the silica powder, and Table 2 shows physical properties of the silica powder.

### Comparative Example 1-2

Silica powder B was prepared and measured in a similar manner to Example 1-1, except that the polypropylene filtration filter used in wet filtration was changed from opening size of 3 μm to opening size of 7 μm. Table 1 shows properties and a preparation condition of the silica powder, and Table 2 shows physical properties of the silica powder.

### Comparative Example 1-3

Silica powder C was prepared and measured in similar manner to Example 1-1, except that the polypropylene filtration filter used in wet filtration was changed from opening size of 3 μm to opening size of 10 μm. Table 1 shows properties and a preparation condition of the silica powder, and Table 2 shows physical properties of the silica powder.

### Comparative Example 1-4

A commercially available spherical silica powder D was measured. Table 1 shows properties of the silica powder, and Table 2 shows physical properties of the silica powder.

### Comparative Example 1-5

A commercially available spherical silica powder E was measured. Table 1 shows properties of the silica powder, and Table 2 shows physical properties of the silica powder.

TABLE 1

| | Silica powder | | | Classification processing Drying treatment | | | | | | | |
|---|---|---|---|---|---|---|---|---|---|---|---|
| | | Specific | | | Filter | | | Pressure | | | |
| | | surface | | | opening | | | is reduced | Firing treatment | | Crush |
| | | area | D50 | Method | size | Temperature | Time | or not | Temperature | Time | processing |
| | | Unit | | | | | | | | | |
| Item | Type | m²/g | μm | — | μm | ° C. | Hr. | — | ° C. | Hr. | — |
| Example 1-1 | 1 | 3 | 1.0 | Wet filtration | 3 | 100 | 15 | Yes | 800 | 10 | Jet mill |
| Example 1-2 | 2 | 3 | 1.0 | Wet filtration | 5 | 100 | 15 | Yes | 800 | 10 | Jet mill |
| Example 1-3 | 3 | 4 | 0.7 | Wet filtration | 3 | 100 | 15 | Yes | 800 | 10 | Jet mill |
| Example 1-4 | 4 | 7 | 0.4 | Wet filtration | 3 | 100 | 15 | Yes | 800 | 10 | Jet mill |
| Example 1-5 | 5 | 24 | 0.1 | Wet filtration | 3 | 100 | 15 | Yes | 800 | 10 | Jet mill |
| Example 1-6 | 6 | 2 | 1.5 | Wet filtration | 3 | 100 | 15 | Yes | 800 | 10 | Jet mill |
| Example 1-7 | 7 | 2 | 1.5 | Wet filtration | 5 | 100 | 15 | Yes | 800 | 10 | Jet mill |
| Example 1-8 | 8 | 9 | 0.4 | Wet filtration | 3 | — | — | — | — | — | — |
| Example 1-9 | 9 | 15 | 0.2 | Wet filtration | 3 | — | — | — | — | — | — |
| Example 1-10 | 10 | 9 | 0.4 | Wind classification | — | — | — | — | — | — | — |
| Comparative | A | 3 | 1.0 | — | — | 100 | 15 | Yes | 800 | 10 | Jet mill |
| Example 1-1 | | | | | | | | | | | |
| Comparative | B | 3 | 1.0 | Wet filtration | 7 | 100 | 15 | Yes | 800 | 10 | Jet mill |
| Example 1-2 | | | | | | | | | | | |
| Comparative | C | 3 | 1.0 | Wet filtration | 10 | 100 | 15 | Yes | 800 | 10 | Jet mill |
| Example 1-3 | | | | | | | | | | | |
| Comparative | D | 6 | 0.7 | — | — | — | — | — | — | — | — |
| Example 1-4 | | | | | | | | | | | |
| Comparative | E | 15 | 0.5 | — | — | — | — | — | — | — | — |
| Example 1-5 | | | | | | | | | | | |

TABLE 2

| | | | | | | | Amount of | | Amount of | |
|---|---|---|---|---|---|---|---|---|---|---|
| | | | | | | Amount of | independent | Amount of | independent | |
| | Specific | | | | | particles | particles | particles | particles | Gap |
| | surface area | D50 | D100 | D100/D50 | V90 | exceeding 5 μm | exceeding 5 μm | exceeding 3 μm | exceeding 3 μm | penetrability |
| | Unit | | | | | | | | | |
| Item | m²/g | μm | μm | — | — | ppm | ppm | ppm | ppm | — |
| Example 1-1 | 3 | 1.0 | 3 | 3 | 45 | 600 | N.D. | 400 | N.D. | Good |
| Example 1-2 | 3 | 1.0 | 3 | 3 | 45 | 600 | N.D. | 400 | 10 | Good |
| Example 1-3 | 4 | 0.7 | 1 | 2 | 25 | 800 | N.D. | 550 | N.D. | Good |
| Example 1-4 | 7 | 0.4 | 1 | 2 | 20 | 1000 | N.D. | 700 | N.D. | Good |
| Example 1-5 | 24 | 0.1 | 0 | 3 | 65 | 1200 | N.D. | 850 | N.D. | Good |
| Example 1-6 | 2 | 1.5 | 4 | 3 | 20 | 200 | N.D. | 100 | N.D. | Good |
| Example 1-7 | 2 | 1.5 | 4 | 3 | 20 | 200 | N.D. | 100 | 10 | Good |
| Example 1-8 | 9 | 0.4 | 1 | 2 | 30 | 1000 | N.D. | 700 | N.D. | Good |
| Example 1-9 | 15 | 0.2 | 0 | 3 | 40 | 1100 | N.D. | 800 | N.D. | Good |
| Example 1-10 | 9 | 0.4 | 1 | 2 | 30 | 1000 | N.D. | 700 | N.D. | Good |
| Comparative | 3 | 1.0 | 3 | 3 | 45 | 1100 | 200 | 1100 | 200 | Poor |
| Comparative | 3 | 1.0 | 3 | 3 | 45 | 1100 | 200 | 1100 | 200 | Poor |
| Comparative | 3 | 1.0 | 3 | 3 | 45 | 1100 | 200 | 1100 | 200 | Poor |
| Comparative | 6 | 0.7 | 3 | 5 | 100 | 1000 | 200 | 700 | 200 | Poor |
| Comparative | 15 | 0.5 | 3 | 7 | 150 | 1300 | 300 | 900 | 300 | Poor |

### Example 2-1

The silica powder 1 prepared in Example 1-1 was put into a mixing container, and stirring was started. After the above, 0.01 parts by mass of hexamethyldisilazane (SZ-31 manufactured by Shin-Etsu Chemical Co., Ltd.) as a surface treatment agent and 0.5 parts by mass of a silane coupling agent (KBM-403 manufactured by Shin-Etsu Chemical Co., Ltd.) were supplied to 100 parts by mass of the silica powder 1 using a peristaltic pump (SJ-1211 II-H manufactured by ATTA). After the supply, the stirring was continued, and mixing was performed for 15 minutes. After mixing, the temperature was raised from room temperature to 40° C. in 20 minutes while stirring was continued, and then the temperature was maintained at 40° C. for 60 minutes. After the above, the temperature was raised to 100° C. in 60 minutes, and then maintained at 100° C. for 180 minutes to complete the reaction process. After completion of the reaction process, cooling was performed, and drying was performed by flowing nitrogen in a container while maintaining the temperature at 30° C. to obtain spherical silica powder surface-treated with a silane coupling agent. Physical properties of the obtained surface-treated silica powder were measured. Table 3 shows properties of the silica powder and a preparation condition of surface-treated silica powder, and Table 4 shows physical properties of the surface-treated silica powder.

### Example 2-2

Surface-treated silica powder was prepared and measured in a similar manner to Example 2-1 except that the silica powder 2 was used instead of the silica powder 1. Table 3 shows properties of the silica powder and a preparation condition of surface-treated silica powder, and Table 4 shows physical properties of the surface-treated silica powder.

### Example 2-3

Surface-treated silica powder was prepared and measured in a similar manner to Example 2-1 except that a surface treatment agent was not used to 100 parts by mass of the silica powder 1 and the silane coupling agent was changed to 0.5 parts by mass of the silane coupling agent (KBM-573 manufactured by Shin-Etsu Chemical Co., Ltd.). Table 3 shows properties of the silica powder and a preparation condition of surface-treated silica powder, and Table 4 shows physical properties of the surface-treated silica powder.

### Example 2-4

Surface-treated silica powder was prepared and measured in a similar manner to Example 2-1 except that 0.01 parts by mass of hexamethyldisilazane (SZ-31 manufactured by Shin-Etsu Chemical Co., Ltd.) and 0.7 parts by mass of a silane coupling agent (KBM-403 manufactured by Shin-Etsu Chemical Co., Ltd.) were used with respect to 100 parts by mass of the silica powder 3. Table 3 shows properties of the silica powder and a preparation condition of surface-treated silica powder, and Table 4 shows physical properties of the surface-treated silica powder.

### Example 2-5

Surface-treated silica particle powder was prepared and measured in a similar manner to Example 2-1 except that 0.02 parts by mass of hexamethyldisilazane (SZ-31 manufactured by Shin-Etsu Chemical Co., Ltd.) and 1.2 parts by mass of a silane coupling agent (KBM-403 manufactured by Shin-Etsu Chemical Co., Ltd.) were used with respect to 100 parts by mass of the silica powder 4. Table 3 shows properties of the silica powder and a preparation condition of surface-treated silica powder, and Table 4 shows physical properties of the surface-treated silica powder.

### Example 2-61

Surface-treated silica powder was prepared and measured in a similar manner to Example 2-1 except that 0.08 parts by mass of hexamethyldisilazane (SZ-31 manufactured by Shin-Etsu Chemical Co., Ltd.) and 4.0 parts by mass of a silane coupling agent (KBM-403 manufactured by Shin-Etsu Chemical Co., Ltd.) were used with respect to 100 parts by mass of the silica powder 5. Table 3 shows properties of the silica powder and a preparation condition of surface-treated silica powder, and Table 4 shows physical properties of the surface-treated silica powder.

### Example 2-7

Surface-treated silica powder was prepared and measured in a similar manner to Example 2-1 except that 0.01 parts by mass of hexamethyldisilazane (SZ-31 manufactured by Shin-Etsu Chemical Co., Ltd.) and 0.3 parts by mass of a silane coupling agent (KBM-403 manufactured by Shin-Etsu Chemical Co., Ltd.) were used with respect to 100 parts by mass of the silica powder 6. Table 3 shows properties of the silica powder and a preparation condition of surface-treated silica powder, and Table 4 shows physical properties of the surface-treated silica powder.

### Example 2-8

Surface-treated silica powder was prepared and measured in a similar manner to Example 2-1 except that 0.01 parts by mass of hexamethyldisilazane (SZ-31 manufactured by Shin-Etsu Chemical Co., Ltd.) and 0.3 parts by mass of a silane coupling agent (KBM-403 manufactured by Shin-Etsu Chemical Co., Ltd.) were used with respect to 100 parts by mass of the silica powder 7. Table 3 shows properties of the silica powder and a preparation condition of surface-treated silica powder, and Table 4 shows physical properties of the surface-treated silica powder.

### Example 2-9

Surface-treated silica powder was prepared and measured in a similar manner to Example 2-1 except that 0.03 parts by mass of hexamethyldisilazane (SZ-31 manufactured by Shin-Etsu Chemical Co., Ltd.) and 1.5 parts by mass of a silane coupling agent (KBM-403 manufactured by Shin-Etsu Chemical Co., Ltd.) were used with respect to 100 parts by mass of the silica powder 8. Table 3 shows properties of the silica powder and a preparation condition of surface-treated silica powder, and Table 4 shows physical properties of the surface-treated silica powder.

### Example 2-10

Surface-treated silica powder was prepared and measured in a similar manner to Example 2-1 except that 0.05 parts by mass of hexamethyldisilazane (SZ-31 manufactured by Shin-Etsu Chemical Co., Ltd.) and 2.5 parts by mass of a silane coupling agent (KBM-403 manufactured by Shin-Etsu Chemical Co., Ltd.) were used with respect to 100 parts by mass of the silica powder 9. Table 3 shows properties of the silica powder and a preparation condition of surface-treated silica powder, and Table 4 shows physical properties of the surface-treated silica powder.

### Example 2-11

Surface-treated silica powder was prepared and measured in a similar manner to Example 2-1 except that 0.03 parts by mass of hexamethyldisilazane (SZ-31 manufactured by Shin-Etsu Chemical Co., Ltd.) and 1.5 parts by mass of a silane coupling agent (KBM-403 manufactured by Shin-Etsu Chemical Co., Ltd.) were used with respect to 100 parts by mass of the silica powder 10. Table 3 shows properties of the silica powder and a preparation condition of surface-treated silica powder, and Table 4 shows physical properties of the surface-treated silica powder.

### Example 2-12

Surface-treated silica powder was prepared and measured in a similar manner to Example 2-1 except that 0.01 parts by mass of hexamethyldisilazane (SZ-31 manufactured by Shin-EtsuChemical Co., Ltd.) and 0.2 parts by mass of a silane coupling agent (KBM-403 manufactured by Shin-Etsu Chemical Co., Ltd.) were used with respect to 100 parts by mass of the silica powder 1. Table 3 shows properties of the silica powder and a preparation condition of surface-treated silica powder, and Table 4 shows physical properties of the surface-treated silica powder.

### Example 2-13

Surface-treated silica powder was prepared and measured in a similar manner to Example 2-1 except that 0.01 parts by mass of hexamethyldisilazane (SZ-31 manufactured by Shin-Etsu Chemical Co., 5 Ltd.) and 1.2 parts by mass of a silane coupling agent (KBM-403 manufactured by Shin-Etsu Chemical Co., Ltd.) were used with respect to 100 parts by mass of the silica powder 1. Table 3 shows properties of the silica powder and a preparation condition of surface-treated silica powder, and Table 4 shows physical properties of the surface-treated silica powder.

### Example 2-14

Surface-treated silica powder was prepared and measured in a similar manner to Example 2-1 except that 0.01 parts by mass of hexamethyldisilazane (SZ-31 manufactured by Shin-Etsu Chemical Co., Ltd.) and 2.4 parts by mass of a silane coupling agent (KBM-403 manufactured by Shin-Etsu Chemical Co., Ltd.) were used with respect to 100 parts by mass of the silica powder 1. Table 3 shows properties of the silica powder and a preparation condition of surface-treated silica powder, and Table 4 shows physical properties of the surface-treated silica powder.

### Comparative Example 2-1

Surface-treated silica powder was prepared and measured in a similar manner to Example 2-1 except that the silica powder A prepared in Comparative example 1-1 was used instead of the silica powder 1. Table 3 shows properties of the silica powder and a preparation condition of surface-treated silica powder, and Table 4 shows physical properties of the surface-treated silica powder.

### Comparative Example 2-2

Surface-treated silica powder was prepared and measured in a similar manner to Example 2-1 except that the silica powder B prepared in Comparative example 1-2 was used instead of the silica particle powder 1. Table 3 shows properties of the silica powder and a preparation condition of surface-treated silica powder, and Table 4 shows physical properties of the surface-treated silica powder.

### Comparative Example 2-3

Surface-treated silica powder was prepared and measured in a similar manner to Example 2-1 except that the silica powder C prepared in Comparative example 1-3 was used instead of the silica powder 1. Table 3 shows properties of the silica powder and a preparation condition of surface-treated silica powder, and Table 4 shows physical properties of the surface-treated silica powder.

### Comparative Example 2-4

Surface-treated silica powder was prepared and measured in a similar manner to Example 2-1 except that the commercially available spherical silica powder D of Comparative example 14 was used instead of the silica powder 1, and 0.01 parts by mass of hexamethyldisilazane (SZ-31 manufactured by Shin-Etsu Chemical Co., Ltd.) and 0.9 parts by mass of a silane coupling agent (KBM-403 manufactured by Shin-Etsu Chemical Co., Ltd.) were used with respect to 100 parts by mass of the spherical silica powder D. Table 3 shows properties of the silica powder and a preparation condition of surface-treated silica powder, and Table 4 shows physical properties of the surface-treated silica powder.

### Comparative Example 2-5

Surface-treated silica powder was prepared and measured in a similar manner to Example 2-1 except that the commercially available spherical silica powder D of Comparative example 14 was used instead of the silica powder 1, and 0.01 parts by mass of hexamethyldisilazane (SZ-31 manufactured by 15 Shin-Etsu Chemical Co., Ltd.) and 0.9 parts by mass of a silane coupling agent (KBM-403 manufactured by Shin-Etsu Chemical Co., Ltd.) were used with respect to 100 parts by mass of the spherical silica powder D. Table 3 shows properties of the silica powder and a preparation condition of surface-treated silica powder, and Table 4 shows physical properties of the surface-treated silica powder.

TABLE 3

| | | | | | | Surface treatment | | | | | | |
|---|---|---|---|---|---|---|---|---|---|---|---|---|
| | Silica powder | | | Coupling agent | | agent | | Heating | | | | |
| | | Specific | | | Usage | | Usage | treatment | | Drying treatment | | |
| | | surface area | D50 | Type | amount | Type | amount | Temperature | Time | Pressure | Temperature | Time |
| | | Unit | | | | | | | | | | |
| | | | | | Parts | | Parts | | | | | |
| Item | Type | m²/g | μm | — | by mass | — | by mass | ° C. | Hr. | hPa | ° C. | Hr. |
| Example 2-1 | 1 | 3 | 1.0 | KBM-403 | 0.5 | SZ-31 | 0.01 | 100 | 3 | 1030 | 50 | 12 |
| Example 2-2 | 2 | 3 | 1.0 | KBM-403 | 0.5 | SZ-31 | 0.01 | 100 | 3 | 1030 | 50 | 12 |
| Example 2-3 | 1 | 3 | 1.0 | KBM-573 | 0.5 | — | — | 100 | 3 | 1030 | 50 | 12 |
| Example 2-4 | 3 | 4 | 0.7 | KBM-403 | 0.7 | SZ-31 | 0.01 | 100 | 3 | 1030 | 50 | 12 |
| Example 2-5 | 4 | 7 | 0.4 | KBM-403 | 1.2 | SZ-31 | 0.02 | 100 | 3 | 1030 | 50 | 12 |
| Example 2-6 | 5 | 24 | 0.1 | KBM-403 | 4.0 | SZ-31 | 0.08 | 100 | 3 | 1030 | 50 | 12 |
| Example 2-7 | 6 | 2 | 1.5 | KBM-403 | 0.3 | SZ-31 | 0.01 | 100 | 3 | 1030 | 50 | 12 |
| Example 2-8 | 7 | 2 | 1.5 | KBM-403 | 0.3 | SZ-31 | 0.01 | 100 | 3 | 1030 | 50 | 12 |
| Example 2-9 | 8 | 9 | 0.4 | KBM-403 | 1.5 | SZ-31 | 0.03 | 100 | 3 | 1030 | 50 | 12 |
| Example 2-10 | 9 | 15 | 0.2 | KBM-403 | 2.5 | SZ-31 | 0.05 | 100 | 3 | 1030 | 50 | 12 |
| Example 2-11 | 10 | 9 | 0.4 | KBM-403 | 1.5 | SZ-31 | 0.03 | 100 | 3 | 1030 | 50 | 12 |
| Example 2-12 | 1 | 3 | 1.0 | KBM-403 | 0.2 | SZ-31 | 0.01 | 100 | 3 | 1030 | 50 | 12 |
| Example 2-13 | 1 | 3 | 1.0 | KBM-403 | 1.2 | SZ-31 | 0.01 | 100 | 3 | 1030 | 50 | 12 |
| Example 2-14 | 1 | 3 | 1.0 | KBM-403 | 2.4 | SZ-31 | 0.01 | 100 | 3 | 1030 | 50 | 12 |
| Comparative | A | 3 | 1.0 | KBM-403 | 0.5 | SZ-31 | 0.01 | 100 | 3 | 1030 | 50 | 12 |
| Example 2-1 | | | | | | | | | | | | |
| Comparative | B | 3 | 1.0 | KBM-403 | 0.5 | SZ-31 | 0.01 | 100 | 3 | 1030 | 50 | 12 |
| Example 2-2 | | | | | | | | | | | | |
| Comparative | C | 3 | 1.0 | KBM-403 | 0.5 | SZ-31 | 0.01 | 100 | 3 | 1030 | 50 | 12 |
| Example 2-3 | | | | | | | | | | | | |
| Comparative | D | 6 | 0.7 | KBM-403 | 0.9 | SZ-31 | 0.01 | 100 | 3 | 1030 | 50 | 12 |
| Example 2-4 | | | | | | | | | | | | |
| Comparative | E | 15 | 0.5 | KBM-403 | 2.5 | SZ-31 | 0.01 | 100 | 3 | 1030 | 50 | 12 |
| Example 2-5 | | | | | | | | | | | | |

TABLE 4

| | Silica powder surface-treated with silane coupling agent | | | | | | |
|---|---|---|---|---|---|---|---|
| | | | | | | Component | |
| | | | | | Specific | amount | Amount of |
| | | | D100/ | | surface | of silane | particles |
| | D50 | D100 | D50 | V90 | area | coupling agent | exceeding 5 μm |
| | Unit | | | | | | |
| Item | μm | μm | — | — | m²/g | molecules/nm² | ppm |
| Example 2-1 | 1.0 | 3 | 3 | 45 | 3 | 4.2 | 600 |
| Example 2-2 | 1.0 | 3 | 3 | 45 | 3 | 4.2 | 600 |
| Example 2-3 | 1.0 | 3 | 3 | 45 | 3 | 4.2 | 600 |
| Example 2-4 | 0.7 | 1 | 2 | 25 | 4 | 4.2 | 800 |
| Example 2-5 | 0.4 | 1 | 2 | 20 | 7 | 4.2 | 1000 |
| Example 2-6 | 0.1 | 0 | 3 | 65 | 24 | 4.2 | 1200 |
| Example 2-7 | 1.5 | 4 | 3 | 20 | 2 | 4.2 | 200 |
| Example 2-8 | 1.5 | 4 | 3 | 20 | 2 | 4.2 | 200 |
| Example 2-9 | 0.4 | 1 | 2 | 30 | 9 | 4.2 | 1000 |
| Example 2-10 | 0.2 | 0 | 3 | 40 | 15 | 4.2 | 1100 |
| Example 2-11 | 0.4 | 1 | 2 | 30 | 9 | 4.2 | 1000 |
| Example 2-12 | 1.0 | 3 | 3 | 45 | 3 | 2.0 | 600 |
| Example 2-13 | 1.0 | 3 | 3 | 45 | 3 | 10.0 | 600 |
| Example 2-14 | 1.0 | 3 | 3 | 45 | 3 | 20.0 | 600 |
| Comparative | 1.0 | 3 | 3 | 45 | 3 | 4.2 | 1100 |
| Example 2-1 | | | | | | | |
| Comparative | 1.0 | 3 | 3 | 45 | 3 | 4.2 | 1100 |
| Example 2-2 | | | | | | | |
| Comparative | 1.0 | 3 | 3 | 45 | 3 | 4.2 | 1100 |
| Example 2-3 | | | | | | | |
| Comparative | 0.7 | 3 | 5 | 100 | 6 | 4.2 | 1000 |
| Example 2-4 | | | | | | | |
| Comparative | 0.5 | 3 | 7 | 150 | 15 | 4.2 | 1300 |
| Example 2-5 | | | | | | | |

| | Silica powder surface-treated with silane coupling agent | | | |
|---|---|---|---|---|
| | Amount of | | Amount of | |
| | independent | Amount of | independent | |
| | particles | particles | particles | Gap |
| | exceeding 5 μm | exceeding 3 μm | exceeding 3 μm | penetrability |
| | Unit | | | |
| Item | ppm | ppm | ppm | — |
| Example 2-1 | N.D. | 400 | N.D. | Good |
| Example 2-2 | N.D. | 400 | 10 | Good |
| Example 2-3 | N.D. | 400 | N.D. | Good |
| Example 2-4 | N.D. | 550 | N.D. | Good |
| Example 2-5 | N.D. | 700 | N.D. | Good |
| Example 2-6 | N.D. | 850 | N.D. | Good |
| Example 2-7 | N.D. | 100 | N.D. | Good |
| Example 2-8 | N.D. | 100 | 10 | Good |
| Example 2-9 | N.D. | 700 | N.D. | Good |
| Example 2-10 | N.D. | 800 | N.D. | Good |
| Example 2-11 | N.D. | 700 | N.D. | Good |
| Example 2-12 | N.D. | 400 | N.D. | Good |
| Example 2-13 | N.D, | 400 | N.D. | Good |
| Example 2-14 | N.D. | 400 | N.D. | Good |
| Comparative | 200 | 1100 | 200 | Poor |
| Example 2-1 | | | | |
| Comparative | 200 | 1100 | 200 | Poor |
| Example 2-2 | | | | |
| Comparative | 200 | 1100 | 200 | Poor |
| Example 2-3 | | | | |
| Comparative | 200 | 700 | 200 | Poor |
| Example 2-4 | | | | |
| Comparative | 300 | 900 | 300 | Poor |
| Example 2-5 | | | | |

In the silica powder of Examples 1-1 to 1-9 in which filtration was performed with a filter having opening size of 5 μm or less, independent particles exceeding 5 μm were removed, and an amount of independent particles exceeding 5 μm was set to less than 100 ppm, and the silica powder of Example 1-10 in which classification was performed with a wind power classification device, independent particles exceeding 5 μm were removed, and an amount of independent particles exceeding 5 μm was set to less than 100 ppm, gap penetrability was good.

On the other hand, in the spherical silica powder of Comparative example 1-1 in which an amount of independent particles exceeding 5 μm was 100 ppm or more without performing filter filtration, Comparative examples 1-2 to 1-3 in which an amount of independent particles exceeding 5 μm was 100 ppm or more by performing filter filtration with opening size of 5 μm or more, and Comparative examples 1-4 to 1-5 in which an amount of independent particles exceeding 5 μm was 100 ppm or more by measuring the commercial product, gap penetrability was poor.

Also in surface-treated silica powder, regardless of a type of a treatment agent, the silica powders of Examples 2-1 to 2-14, in which filter filtration with opening size of 5 μm or less or wind power classification was applied, independent particles exceeding 5 μm were removed, and an amount of independent particles exceeding 5 μm was set to less than 100 ppm, had good gap penetrability.

On the other hand, in the spherical silica powder of Comparative example 2-1 in which an amount of independent particles exceeding 5 μm was 100 ppm or more without performing filter filtration, Comparative examples 2-2 to 2-3 in which an amount of independent particles exceeding 5 μm was 100 ppm or more by performing filter filtration with opening size of 5 μm or more, and Comparative examples 24 to 2-5 in which an amount of independent particles exceeding 5 μm was 100 ppm or more by using the commercial product, gap penetrability was poor.

1. Silica powder containing a spherical silica particle, whose dispersion liquid dispersed by a dispersion method A has a volume-based cumulative 50% diameter D50 of 0.05 to 2.00 μm and a volume-based cumulative 100% diameter D100 of 5 μm or less by a laser diffraction scattering method, and whose dispersion liquid dispersed by a dispersion method B has an amount of particles exceeding 5 μm of 100 ppm or more and an amount of independent particles exceeding 5 μm of less than 100 ppm as detected by a dynamic image analysis method:
[Dispersion method A] a method of dispersing a 5 mass % ethanol suspension of silica powder in an ultrasonic homogenizer at a frequency of 20 kHz for 5 minutes; and
[Dispersion method B] a method in which a 0.1 mass % aqueous suspension of silica powder is dispersed for 30 minutes in an ultrasonic cleaner at a frequency of 40 KHz.

2. The silica powder according to claim 1, wherein:
the spherical silica particle is surface-treated with a silane coupling agent, and a component amount of the silane coupling agent is 2.0 to 22.0 molecules/nm².

3. The silica powder according to claim 2, wherein:
a ratio (D100/D50) of a volume-based cumulative 50% diameter D50 (μm) to a 100 volume-based cumulative 100% diameter D100 (μm) obtained by a laser diffraction scattering method is 1 or more and 5 or less.

4. The silica powder according to claim 2, wherein:
an amount (V90) of coarse particles of the silica powder, which is obtained by Formula (1) from a volume-based cumulative 50% diameter D50 and a volume-based cumulative 90% diameter D90 obtained by a laser diffraction scattering method, is 10 or more and less than 100.
$$V 90 = \{ ( D 90 - D 50 ) / D 50 \} \times 100 \qquad ( 1 )$$

5. Resin composition comprising the silica powder according to claim 2 dispersed in resin.

6. A dispersion comprising the silica powder according to claim 2 dispersed in a solvent.
